(19) United States
(12) Patent Application Publication
(10) Pub. No.: US 2022/0374919 A1
(43) Pub. Date: Nov. 24, 2022

(54) QUANTUM PSYCHOTHOTONIX SYSTEM AND METHOD FOR MODELING AND INFLUENCING EMOTIONAL AND BEHAVIORAL STATES

(71) Applicants: Richard Conner, Orange, CA (US); Marcus Carlos Rodriguez, Las Cruces, NM (US)

(72) Inventors: Richard Conner, Orange, CA (US); Marcus Carlos Rodriguez, Las Cruces, NM (US)

(21) Appl. No.: 17/321,457

(22) Filed: May 16, 2021

(51) Int. Cl. G06Q 30/02; G06N 10/00; G06K 9/00

(52) U.S. Cl. CPC G06Q 30/0201; G06N 10/00; G06Q 30/0261; G06K 9/00335

(57) ABSTRACT

A method for gauging target population response including: presenting, with a client device, a psychothotonix questionnaire derived from an emotional behavioral plane; acquiring a psychothotonix response data based on the psychothotonix questionnaire, the psychothotonix response data comprise at least an emotional response data and a behavioral response data; aggregating the psychothotonix response data to a centralized database; processing the psychothotonix response data with a psychothotonic computer program; embedding the psychothotonic computer program to a quantum hardware; executing the psychothotonic computer program; and producing at least one or more commands that are configured to be operable for influencing at least one of, a decision making in at least one of a variety of marketing and advertising contexts, how humans perceive their environment, and viewer behavior.

### CROSS-REFERENCE TO RELATED APPLICATIONS

Not applicable.

### RELATED CO-PENDING U.S. PATENT APPLICATIONS

Not applicable.

### INCORPORATION BY REFERENCE OF SEQUENCE LISTING PROVIDED AS ATEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to quantum psychothotonix. More particularly, certain embodiments of the invention relate to a system and method for quantum psychothotonix for modeling and influencing emotional and behavioral states.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Quantum psychothotonix may involve principles from several major fields, including but not limited to, quantum computing, psychology, and photonics. As used herein, quantum computing may refer to processes for information manipulation using principles and hardware inspired from quantum physics. Psychology may be the scientific study of the human mind and behavioral interactions. Photonics may be the physical science of light generation, detection, and manipulation through emission, transmission, modulation, signal processing, switching, amplification, and sensing.

A photon may carry energy proportional to a radiation frequency and may have zero rest mass. Photons may be the basis of objective external reality which becomes subjective internal reality when image information is processed by human beings—biological quantum image processors or any other forms of evolved consciousness. External images may be made up of photons, which are particles that represent a quantum of light or other electromagnetic radiation. Conversely, a thoton may be an internal non-matter image. The thoton is the dual opposite of a photon which may carry physical image information of external objective reality versus a non-matter image of internal subjective reality. Altering thotonic identity may also result in conscious changes. For example, thotonic change may result in a viewer picturing themselves buying a particular product or donating to a certain cause.

Generally, psychology may be a scientific field which studies the human mind and behavior. A sub-field of psychology, psychothotonix may be the measurement and control of human perceptions and related human behavior patterns based on space-time imaging.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that many modern companies and governments may apply psychological principles for manipulating viewer images to achieve industrial, commercial, and/or political goals. However, one problem with current methods for image based psychological influence is that computational power requirements may restrict processing capabilities for data driven demands and the lack of a quantifiable model of reality that embodies intangible emotional behavioral states. Moreover, another problem with current methods may be a lack of specificity for influencing particular users or viewers.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary emotional behavioral plane, in accordance with an embodiment of the present invention;

FIG. 2 illustrates an exemplary Internal I* Space Time Mapping, in accordance with an embodiment of the present invention;

FIG. 3 illustrates an exemplary qubit mapping table, in accordance with an embodiment of the present invention;

FIG. 4a illustrates an exemplary sampling question chart, and FIG. 4b illustrates an exemplary corresponding map of the psychothotonix sample question to an ambiguous image of an adult interacting, in accordance with an embodiment of the present invention;

FIG. 5a illustrates a flowchart depicting an exemplary method for utilizing quantum psychothotonix for modeling and influencing emotional and behavioral states, and FIG. 5b illustrates an Extended Image Wave Equation (Unified Equation of Reality), that carry out the psychothotonix modeling and influencing emotional and behavioral states, in accordance with an embodiment of the present invention;

FIG. 6 illustrates a flow chart of an exemplary method for gathering and utilizing psychothotonix questionnaire data, in accordance with an embodiment of the present invention;

FIG. 7 illustrates a flow chart of an exemplary method for utilizing psychothotonic data for altering a thotonic identity, in accordance with an embodiment of the present invention;

FIG. 8 is a block diagram depicting an exemplary client/server system which may be used by an exemplary web-enabled/networked embodiment of the present invention; and

FIG. 9 illustrates a block diagram depicting a conventional client/server communication system, which may be used by an exemplary web-enabled/networked embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. July 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [”substantially“] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising” And “contain” and variations of them—Such terms are open—ended and mean “including but not limited to”. When employed in the appended claims, this term does not foreclose additional structure or steps. Consider a claim that recites: “A memory controller comprising a system cache . . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

All terms of exemplary language (e.g., including, without limitation, “such as”, “like”, “for example”, “for instance”, “similar to”, etc.) are not exclusive of any other, potentially, unrelated, types of examples; thus, implicitly mean “by way of example, and not limitation . . . ”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Moreover, any claim limitation phrased in functional limitation terms covered by 35 USC § 112(6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s).

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

While embodiments herein may be discussed in terms of a processor having a certain number of bit instructions/data, those skilled in the art will know others that may be suitable such as 16 bits, 32 bits, 64 bits, 128s or 256-bit processors or processing, which can usually alternatively be used. Where a specified logical sense is used, the opposite logical sense is also intended to be encompassed.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object-oriented programming language such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods, and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods, and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random-access memory (DRAM), which typically constitutes the main memory. Transmission media include coaxial cables, copper wire and fiber optics, including the wires that comprise a system bus coupled to the processor. Transmission media may include or convey acoustic waves, light waves, and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards, or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Additionally, the phrase “configured to” or “operable for” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor-based memory, phase change memory, optical memory, periodically refreshed memory, and the like; the non-transitory computer readable medium, however, does not include a pure transitory signal per se; i.e., where the medium itself is transitory. One aspect of the present invention may be a methodology for psychothotonix using quantum computing. The methods may statistically gauge target population behavioral response to images, thus providing the ability to tailor imaging to achieve corporate or campaign objectives. First, data may be mined, organized, and aggregated to a centralized database with demographic and psychological population information. In certain embodiments, the database may be cleaned and secured offline prior to processing. Second, quantum algorithms may be constructed and embedded on a quantum computer to process the centralized database. The quantum computer may be physical system for the harnessing of quantum effects to perform computation. In contrast to conventional computers, the quantum computer or hardware may process information using qubits, which represent information in a complex vector space instead of binary bits. A qubit or quantum bit, may represent, for example, without limitation, a zero, one, or zero and one simultaneously in a state of superposition. The mathematical abstraction associated with qubits may mirror the difference between classical and quantum states in physics. The qubit may be used to improve the efficiency and power of classical computing methodologies with quantum mechanics. In certain embodiments, the algorithms may map to four physical qubits, representing human emotion and behavioral response as a two-state quantum system. The brain may be thought of as a camera that takes images and stores them for many different types of interpretations of external reality—so the brain may be an image processor with its own internal universe space-time coordinate system. The psychothotonix model introduces the brain interaction space-time mathematical model—a logical expansion of standard tensor calculus and quantum mechanics. The brain is composed of atoms that are quantum in nature and in some mysterious way emit light (photons) in the brain that somehow form images as well as image interpretations of the external world. However, even though the field of biopsychology based on the neurological study of this phenomenon is intriguing, it has no bearing on our model as it relates to measuring and controlling human perceptions. It is apparent that we all have images in our brain and that is what is important for modeling decisions, emotions, and behavior patterns. The mechanics of how the images form is irrelevant. By way of example, and not limitation, the system and method for quantum psychothotonix are principally directed to measuring and influencing emotional and behavioral states with implementations based on dualistic, two state quantum systems.

The psychothotonix model is based on acquiring time series of human emotional, behavioral and decision data or statistically deriving it from the quantum mechanical modeling representing (B)ehaviour, (E)motions and (D)ecisions, which are the quantifiable coordinates replacing x, y, and z as points on a psychothotonix brain sphere. The brain sphere moves in physical space-time on some curve relative to the external image. Consequently, there is a mapping of (B), (E), (D) to x, y, z in time. This psychothotonix spacetime coordinate system defines emotional/behavioral/decision reality as interpreted by a brain at a given moment I1(B), I2(E), I3(D). “I” stands for the observer's “thotonic identity” at the time of observation of the external event because we are capturing each “I” in a time series on the psychothotonix computer and or camera—a frame at a time. We define this as a person's identity. The previous images impact your perception of the present and future images. Over time the frames add up to your identity, which are also your image interpretations building up over time. This is how you perceive the external and this influences your interpretation of events as the frames stack up. Your total I would be the sum of all I (time) from birth to death. The orthogonal axis, moving in time is demonstrative of our unique duality methodology where all the coordinates are of unit length—the same coordinates for all human brains.

The brain interprets external images from physical space time (x, y, z, t) as points on internal image spheres. Imagine a line R originating from the center of the sphere as a duality pointing vector, which symbolically connects to a person's interpretation of some external event. R is the vector that connects to some external image at a point in physical space time — both are orthogonal systems and have a unique mapping from one internal point to an external point in physical space-time. A person could enter data manually on a psychothotonix questionnaire creating a path of points curving this way and that way tracing points on the sphere moving in time. The basic idea is that the curve in tensor math is easiest to calculate using the first fundamental form. The curve is just ds (t)/dt where ds(t)/dt is the arc length along the path on the sphere and ds2=the metric tensor g (ij)dI(i)dI(j). So, s is just the time integral of the square root of the first fundamental form—a super easy equation to program. A quantum computer-based embodiment of psychothotonix technology applies gates: Hadamard, R(X), CNOT, (X) to qubits (Bloch Spheres) based on direct responses to the psychothotonix questionnaire or direct input from a hyperspectral or traditional camera. As the utilized quantum gates are unitary, users could plot this out relative to outside stimulus by reversing the gates to show how they moved along on their brain spheres. Quantum gates are unitary, because they are implemented via the action of a Hamiltonian for a specific time, which gives a unitary time evolution according to the Schrodinger equation. Finally, all people interpret any external objective image and even our own internal images (for example interpreting images from a dream) described by these two coordinate systems.

Duality is the fundamental and non-reducible characteristic common to all human brains. This makes the coordinates extremely easy to understand and put into mathematical formulas that are an extension in logic to all existing math models of the external physical universe. Consider a simple example of defining a two-state quantum system on the psychothotonix spheres as it relates to the example of deciding to buy a new car I3 (D, t) is one unit in length (1=Buy, 0=Don't Buy). The decision is ultimately dualistic—I am going to decide to either buy the car or not at some point tin physical space time based on the relative internal time (i, t). In this example, assume the car salesperson has done a fair job of explaining the benefits of the new model versus my old car. It is electric and will save me money each month on gas, but he also says it has a limited range of miles before it must be charged. My decision state at t1 is mixed (superposition) as I am undecided whether I will Accept or Resist (behavioral state) the decision of buying. The salesman then explains it comes with lifetime free car washes, changing my mixed behavioral state from t1 to a pure state of “Accept” at time t2 upon processing the internal image (i,t2) of never having to pay for a car wash again resulting in changing I1 (B, t2) to 100% accepting the idea of the decision to buy the car resulting in I3 (D, t2) “Buying” therefore the following two state quantum systems representing the internal image states in the brain can be modeled using three qubits or Bloch Spheres:

|ψ [symbol] =α|000 [symbol] +β|111 [symbol] α+β1

SPHERE2/Qubit(2) (B)ehavior=|0>Reject/|1>Accept

SPHERE1/Qubit(1) (E)motion=|0>Sad/|1>Happy

SPHERE0/Qubit(0) (D)ecision=|0>Don't Buy/|1>Buy.

I1 (B, t)=|ψ [symbol] =α1 √2|000 [symbol] +1√2β|111 [symbol] My internal image behavior state is “Undecided (½ Accept—½ Resist)” due to the limited range of the electric car. (SPHERE 2)

I2(E, t)=[010]/The internal image emotional behavior state is “Happy”. I am 100% percent happy about buying the car, as I can picture it in my driveway (envy of my neighbors) and see myself driving it with a sense of pride and satisfaction. I feel good about it, but . . . (SPHERE 1)

I3 (D, t)=|ω [symbol] =α1√2 |000 [symbol] +1√2 β|111 [symbol] [0=Don't Buy, 1=Buy]I don't know what to do, I can see myself driving it, but I am going to have to plug it in on a long trip to charge, wasting time. Maybe it is not for me. (SPHERE 0)

I1(B, t2)=[110]Free car washes, Accept!

I2(E, t2)=[110]Still happy about it.

I3 (D, t2)=[111] YES! My decision is “Buy”. Where do I sign, can't wait to park it in my driveway!

A quantum computer provides a probabilistic output in the form of a histogram with 2n combinations (n=#Bloch Spheres/Qubits) after a predetermined number of shots. Alternatively, this example could also be mapped as a simple vector in spherical coordinates on a unit sphere. The points on the sphere are just (1, 1, 1). This represents an objective total interpretation of this external event, at a given “moment” when the vectors (data points) are captured on the computer.

Now, introduce duality to the scenario. Let us redo the scene in time. Suppose that I am at a car sales lot. I want to decide about buying a car, or not buying a car. In this example, the salesperson does a horrible job, and I am grieving the loss of my pet hamster. I1 (B, t) now also equals the dual opposite, 0 as I am not swayed into buying the car because the salesman did a poor job. I2 (E, t) now also equals the dual opposite, 0 because I am 100 percent not feeling good because my pet hamster died. I3 (D, t) now equals the dual opposite, 0, as I decided not to purchase the car. The quantum computer output is [000]. The duality vector is (−1, −1, −1). The two vectors are dual opposite, as points on the psychothotonix sphere. Now how about [110]/(1,1, −1)? The salesperson did a good job, I decide not to buy the car I3 (D, t)=0. However, I am 100 percent emotionally positive about it I2 (E, t) =1, because my happiness does not depend on this external event. How about the dual opposite, [001]?

The salesman did a poor job I1 (B, t)=0, I decide to buy the car even though I cannot afford it I3 (D, t)=1 and emotionally 100% do not feel happy about it. I 100% feel sad I2 (E, t)=0 because now I am broke!

The psychothotonix (B)(E)(D) data about my experience is measurable and recordable. That is an example of the four quadrants with dual opposite vectors. Any experience can be modeled this way, there is no other way to put coordinates on emotional behavioral image states without this psychothotonix duality space-time model. It is an irreducible coordinate system just as is the physical space time diagram. What makes it useful is that now we have the same mathematical structure for both and can thus build internal reality a step at a time as well as collect additional data points, previously unavailable. We can connect our experiences with the solid mathematics of tensor calculus but with two basic coordinate systems. One for the observer's brain and one for the observers mapping of external physical events.

External image events are also interconnected between independent observers similar to existing models of quantum communication (Superdense Coding-Teleportation) between observers, as illustrated in the Bob and Alice entanglement concept utilizing bell states. Consider a point (1,1,1) in Bob's brain relative to any external event interpretation. Assume Alice who is halfway around the word had the same interpretation of the same event in her brain. 111=111 on the two spheres. This is called a bijective mapping because either of them can communicate back to each other and maintain the same result. They are entangled. Assume that this mapping happened via the speed of light over the internet. Now Bob sees another point and Alice automatically sees the same point instantly. Their brains are entangled. Once one state of anything is chosen, the other is instantly locked in at infinite speed, essentially. In terms of math, the mapping is one to one, homogenous, and the Jacobian and its inverse product is I, the identity matrix. So, to expand the concept of I, they have the same I, 111=111.

At the core of psychothonix principles are the following tenets:

1.) All internal behavioral/emotional/decision image states in the brain are wave-like, and probabilistic in nature residing in the sub-conscious until they manifest.

2.) Upon collapsing, internal probabilistic image states may be measured and mapped in external space-time (x, y, z, t) as a curve on a unit sphere using tensor calculus.

3.) Internal behavioral/emotional/decision image states are grounded in duality and may be modeled using two-state quantum systems mapped to external space-time coordinate systems (relativity of external/internal images stacked in space and time).

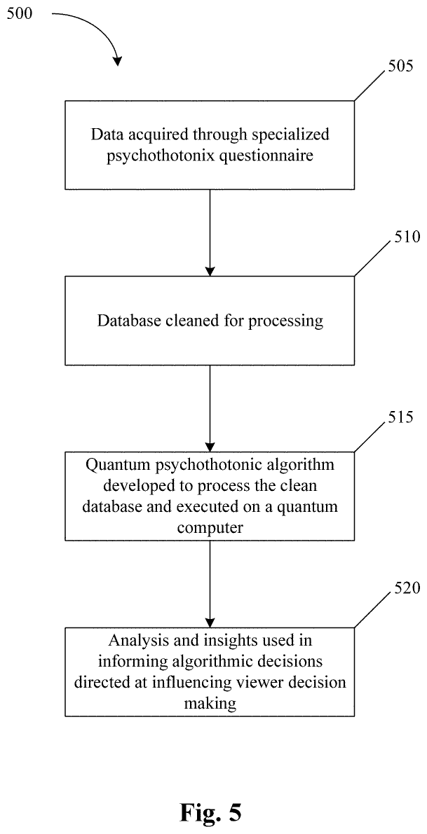

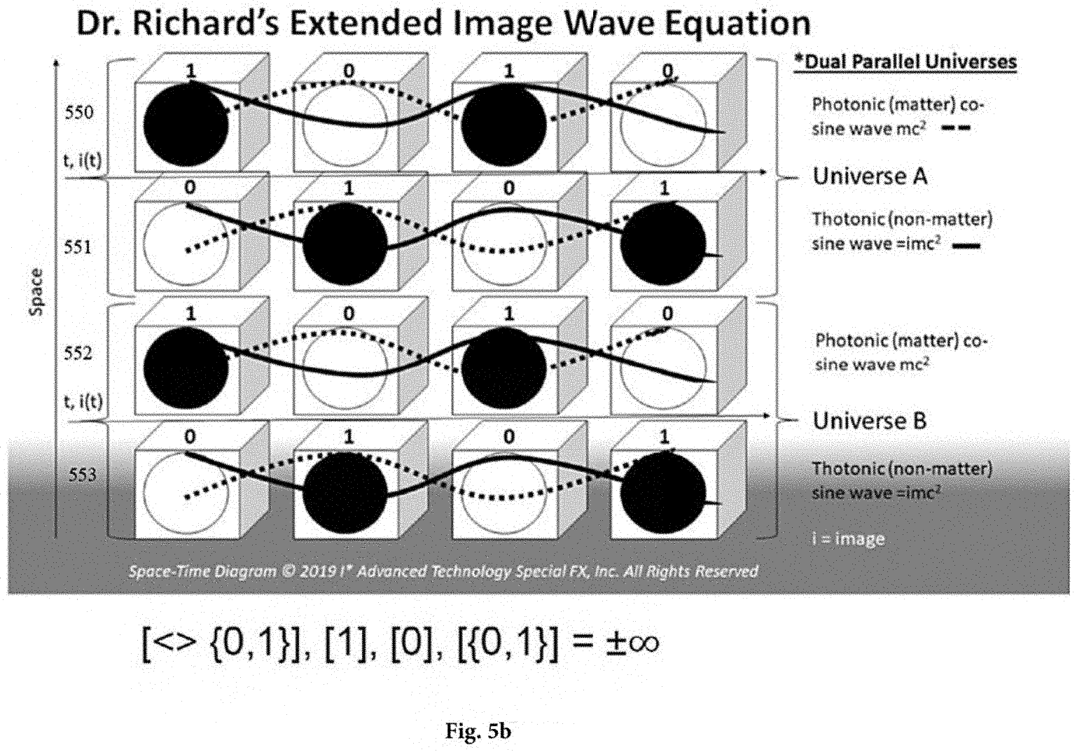

4.) The interaction of the external and internal image states collectively manifests and shapes external objective reality in a continuous feedback loop, as illustrated in Dr. Richard's Extended Image Wave Equation (Unified Equation of Reality, FIG. 5.5) based on the continuous interaction of probabilistic wave frame rates (Modality of Consciousness) ranging from the external rate |1>=ℏ/ΔE to the internal rate of |0>=±∞.

5.) All human emotional image states may be represented by mixed quantum states based on the duality of the pure states of Happiness/Sorrow and Fear/Anger.

6.) Decision internal image states are entangled with emotional, behavioral images states and impact the ultimate dualistic (D)ecision event as the (D)ecision wave collapses into material reality. Internal image states may also create entanglement between independent viewers of an external event.

7.) Any image state that is dualistic may be modeled quantum mechanically as a two-state quantum system.

According to psychothotonic principles, there may be four pure human emotional states, happy, sad, angry, and afraid. The terms psychothotonic and psychothotonix may be used interchangeably. Additionally, there may be four basic behavioral states: accept, resist, control, and flow. Ultimately, emotional states may strongly influence the way in which humans perceive their environment and the resulting behavioral responses impacting human interaction with objective reality, thereby manifesting probabilistic immaterial image waves into material reality.

Quantum algorithms may produce instructions for influencing user behavior. Demographic data aligned with (B)ehavioral, (E)motional and (D)ecision data collected by psychothonix questionnaire, hyperspectral or traditional cameras, or other means could be used as instructions for displaying particular images as it relates to influencing particular (D)ecisions or outcomes. For example, in conformity with the previous example of the new car buyer, certain demographics might respond differently behaviorally and emotionally to the image of “lifetime free car washes”. The instructions would suggest different advertisements for particular demographics based on (B)(E)(D) data and statistical modeling in order to achieve the highest probability of a (D) state of “Buy”. In certain embodiments, the instructions may be used for commanding software targeting information flow to influence users on the internet or to enhance the conversion rate of, for example, without limitation, traditional television video advertising.

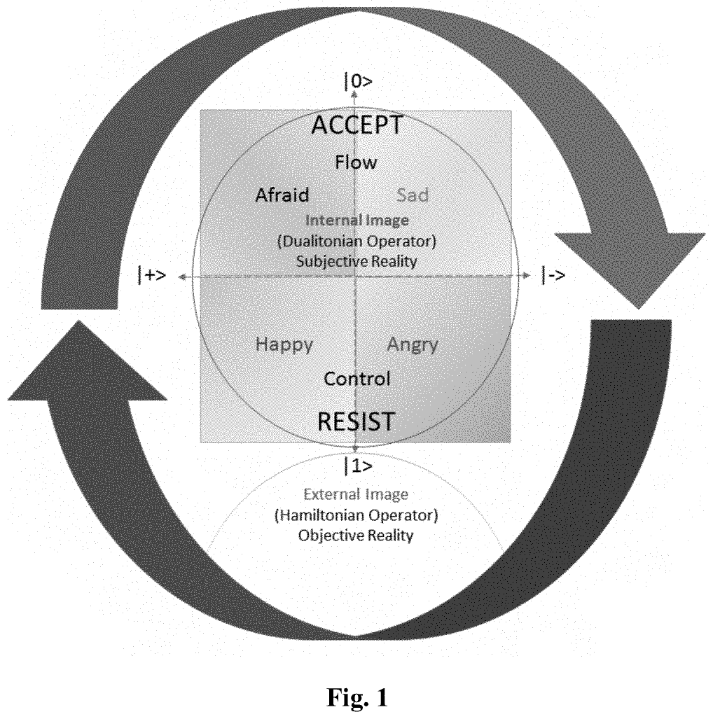

FIG. 1 illustrates an exemplary emotional behavioral plane, in accordance with an embodiment of the present invention. The emotional behavioral plane may be utilized in developing questions for a psychothotonix questionnaire in determining, for example, without limitation, an emotional interpretation of an individual to a specific stimulus. The stimulus may be any type of stimulus known in the art, such as, without limitation, images, videos, advertisements, etc. For example, without limitation, an individual may be presented a video commercial for evaluating the individual's consumer opinion. The video commercial may be presented one scene at a time. The participant may be prompted with a question after each scene is presented and may record an emotional/behavioral state of the participant using the psychothotonix questionnaire derived from the emotional behavioral plane.

“Multi stable Perception” is a natural phenomenon whereby an external image is subject to multiple valid internal perceptions. An example of an ambiguous image that exhibits the characteristics of a multistable perception picture may be seen in Rubin's vase. An image of a black vase in the middle of the picture stands out while two faces are visible in the negative white space. If a participant was queried as to what they see in the picture, both the vase and two faces are an equally valid response as is faces and a vase. This classification of ambiguous images is important to the field of psychology as they are typically used in experimentation. The psychothotonix

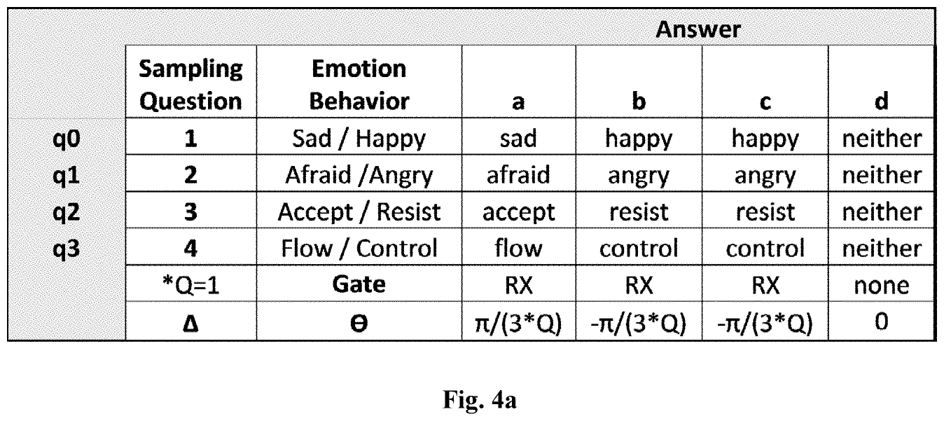

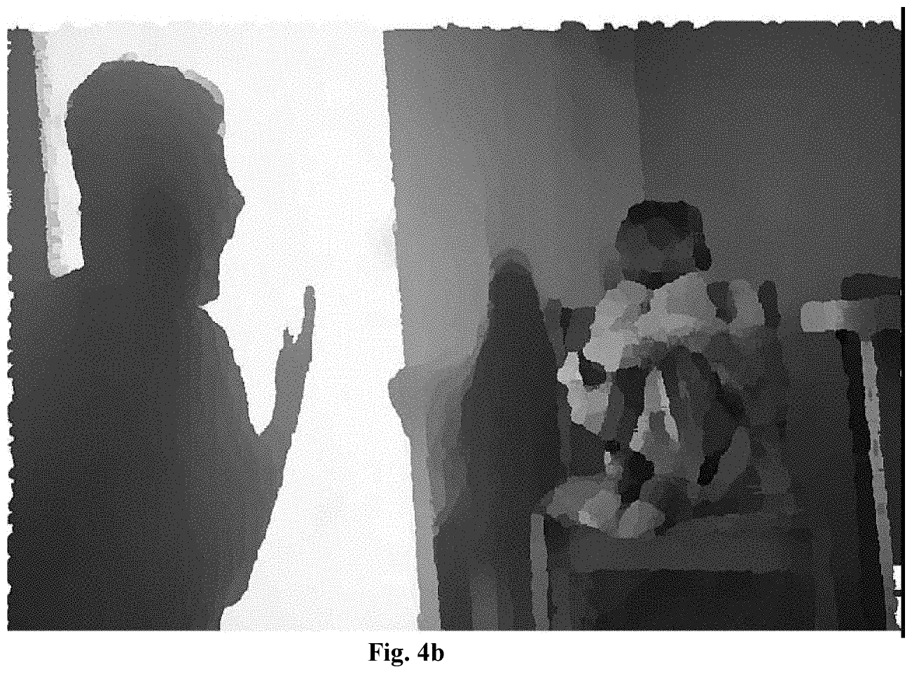

Questionnaire uses ambiguous images that are designed to trigger a strong emotional response and open to dualistic interpretation. The images are constructed to reveal the internal emotional and behavioral image states of the observer. Just like the multistable perception images offer the viewer two valid stable external images that are intertwined with one another, a psychothotonix image creates a stable dualistic emotional, behavioral internal image that is entangled with the viewer's identity. The survey asks the participant basic questions concerning a series of psychothotonix images. Given the ambiguity of the image and dualistic nature of the possible emotional, behavioral interpretations, the survey responses by design reveal more information about the viewer's inner emotional, behavioral wave state than the external image. For Example, (see FIG. 4a and FIG. 4b) that maps a psychothotonix sample question to an ambiguous image of an adult interacting with a child:

Question #1 How does the child feel?

(a) The child is sad because the adult is angry.

(b) The child was happy before the adult became angry.

(c) The child is happy that the adult only yelled at him.

(d) The child is neither happy nor sad.

Question #2 How does the child feel about the adult?

(a) The child is scared of the adult.

(b) The child is angry at the adult.

(c) The child is not afraid of the adult.

(d) The child is neither afraid nor angry at the adult.

Question #3 Who's fault, is it?

(a) It is the child's fault, he/she should listen to the adult.

(b) It is not the child's fault, he/she should explain things to the adult.

(c) The adult is at fault and abusing the child.

(d) Neither the child nor adult is at fault.

Question #4 What should the child do?

(a) Even though the adult is wrong, the child should listen.

(b) The child should scream for his/her other parent.

(c) The child needs to disobey in order to continue to get attention.

(d) There is not enough information to tell.

The participant's response may be translated to a quantum vector, which may be processed to determine the participant's interpretation of an external reality event. The resulting data may be used to demographically model a population's response to the effectiveness of an advertisement based on the primal triggered behavioral response of “Acceptance” or “Resistance”. Various different versions of the commercial may be utilized and modified to achieve a higher potential success rate across a target demographic.

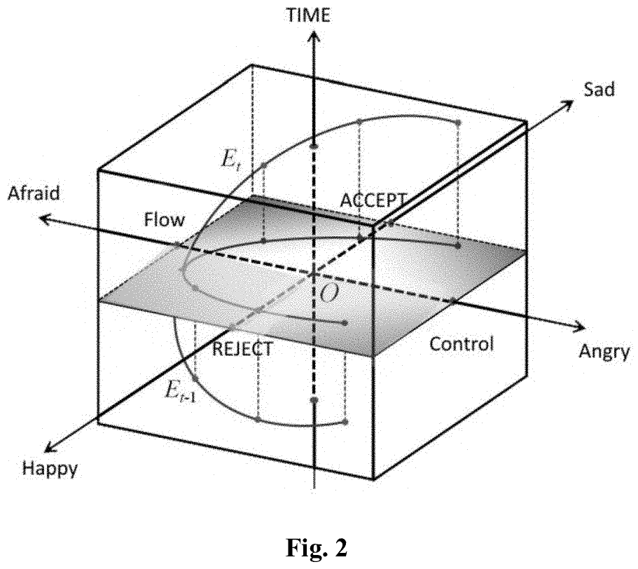

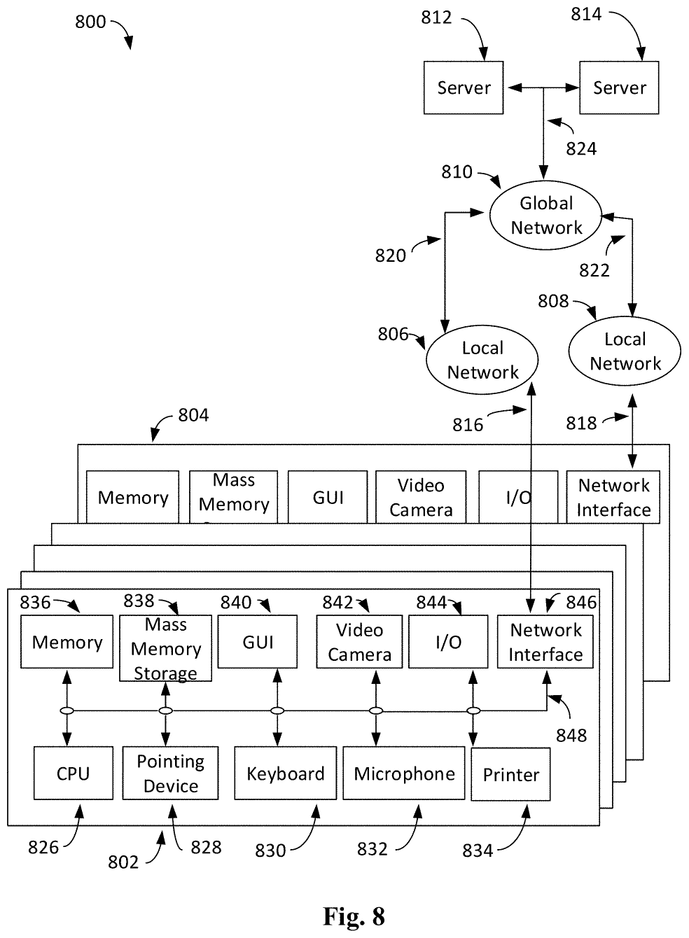

FIG. 2 illustrates an exemplary Internal I* Space Time Mapping, in accordance with an embodiment of the present invention. An internal I* Space Time Mapping may be created using aggregated data corresponding to an individual's internal response to one or more stimuli. While the data may be gathered using psychothotonix questionnaires, as described above with reference to FIG. 1, alternative methods for data gathering may also be utilized. For example, without limitation, a hyperspectral camera, and a conventional camera (e.g., video camera 842 in FIG. 8) may be used to take a picture of an individual being exposed to a stimulus. The hyperspectral image may model the anatomical details (i.e., combinations of independent facial muscles) of the individual's facial features that may uniquely correspond to the individual's internal state in response to the stimulus and may simultaneously submit a questionnaire response. The questionnaire response may be, for example, without limitation, “I am 100 per cent sad while watching this scene”, “I am 50 percent happy while watching this scene”, etc. Such a response may be a different vector in an emotional space time mapping. The vectors from each response may be stacked frame by frame, resulting in the Internal I* Space Time Mapping. The Internal I* Space Time Mapping may be effective at modeling human interpretation of external reality. The external image of the human face along with vectors along the curve of the Internal I* Space Time Mapping may create a mechanism to quantify emotional behavioral characteristics of a person's “inner universe”. The resulting data may be used in a variety of different ways, including, but not limited to, targeted advertising, etc.

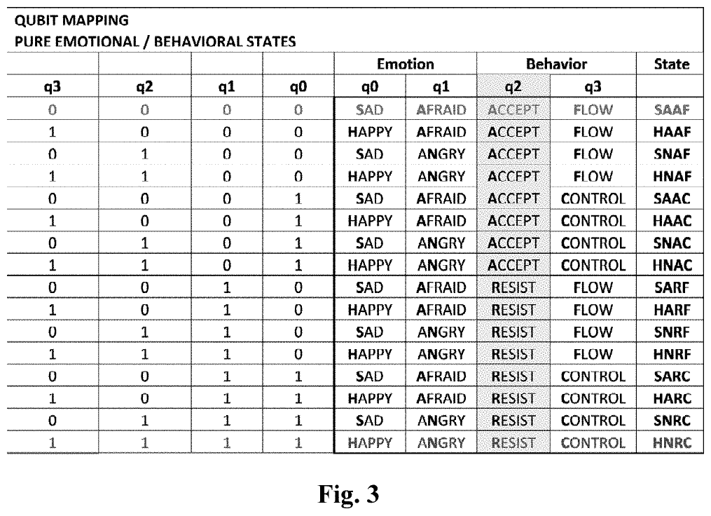

FIG. 3 illustrates an exemplary qubit mapping table, in accordance with an embodiment of the present invention. Individualistic emotional response may be altered based on a given stimulus, and certain emotional and behavioral states may be more susceptible to reacting to such a stimulus. The qubit mapping table may indicate an individual's susceptibility to a change in thotonic identity.

The psychothotonix model is based on acquiring time series of human behavioral data or statistically deriving it from the quantum mechanical modeling representing (B)ehaviour, (E)motions and (D)ecisions, which are the quantifiable coordinates replacing x, y, and z as points on a psychothotonix brain sphere. The brain sphere moves in physical space-time on some curve relative to the external image. Consequently, there is a mapping of B, E, D to x, y, z in time. This psychothotonix spacetime coordinate system defines emotional/behavioral reality as interpreted by a brain at a given moment I1(B), I2(E), I3(D). “I” stands for the observer's “thotonic identity” at the time of observation of the external event because we are capturing each “I” in a time series on the psychothotonix computer and or hyperspectral or traditional camera—a frame at a time. We define this as a person's identity or “thotonic identity”. The previous images impact your perception of the present and future images. Over time the frames add up to your identity, which are also your image interpretations building up over time. This is how you perceive the external and this influences your interpretation of events as the frames stack up. Your total I would be the sum of all I (time) from birth to death.

For example, without limitation, images that result in a “Low” state (i.e. the lower values of the qubit mapping table, the lowest state being 0000) may result in a higher conversion rate, while a population in the “High” state (i.e. the higher values of the qubit mapping table, the highest state being 1111) may be more likely to challenge a change in thotonic identity, resisting any proposed new image that alters currently accepted perceptions and making it more difficult to induce behavior. This may be defined as a four-qubit architecture. The low state of Qubit 1 “Accept” may be a significant factor in a determination of success with varying degrees of magnitude based on the expected value of Qubits 0, 2, and 3. Psychothotonix may provide a methodology for statistically gauging a target population's behavioral response to images as well as the ability to tailor imaging to achieve campaign objectives. For example, without limitation, an initial sequence of imaging designed to set the initial state of a target observer to sad, afraid, accepting, and flowing (0000) during programming may enhance the probability and magnitude of altering thotonic identity.

FIG. 4a illustrates an exemplary sampling question chart, and FIG. 4b illustrates an exemplary corresponding map of the psychothotonix sample question to an ambiguous image of an adult interacting, in accordance with an embodiment of the present invention; in accordance with an embodiment of the present invention. Psychothotonix questionnaires may be used to determine an individual's internal response to stimulus. Similar to a traditional survey, initial questions may capture a participant's general demographics, such as, without limitation, age, gender, income, level of education, occupation, ethnicity, religion, family structure, etc., which may be used for segmentation. Additional information, such as, without limitation, geographic information, may also be recorded. Multistable Perception may be a natural phenomenon whereby an external image may be subject to multiple valid internal perceptions. Such ambiguous images may be designed to trigger a strong emotional response and may be open to dualistic interpretation. The images may be constructed to reveal an internal emotional and behavioral image states of a participant. As such, a psychothotonix image may create a stable dualistic emotional, behavioral internal image that may be entangled with the viewer's identity. A psychothotonix questionnaire may ask a participant basic questions concerning psychothotonix images. The survey responses may reveal more information about a participant's internal emotional, behavioral wave state than the psychothotonix image itself. Once an adequate number of sampling questions have been processed to ascertain a temporal emotional behavioral profile, experimental content may be shown to ascertain the effectiveness of altering states and/or changing thotonic identity (i.e. programming images). Such programming images may be shown via any means known in the art, such as, without limitation, video with still images, online surveys, etc.

The sampling question chart may be used to record the responses of an individual participating in a psychothotonix questionnaire.

FIG. 5a illustrates a flowchart depicting an exemplary method for utilizing quantum psychothotonix for modeling and influencing emotional and behavioral states, and FIG. 5b illustrates an Extended Image Wave Equation (Unified Equation of Reality), that carry out the psychothotonix modeling and influencing emotional and behavioral states, in accordance with an embodiment of the present invention. As illustrated in the figure, Dr. Richard's Extended Image Wave Equation is based on the continuous interaction of probabilistic wave frame rates (Modality of Consciousness) ranging from the external rate |1>=ℏ/ΔE to the internal rate of |0>=. Process 500 may begin with a step 505 in which data may be acquired through various techniques including, for example, without limitation, issuing a specialized psychothotonix questionnaire. The psychothotonix questionnaire may include information such as, without limitation, demographic, emotional, and psychological data, and may be aggregated to an organized database. Referring to FIG. 5 and FIG. 8, In a step 510 of process 500, database 812 or 814 may optionally be cleaned for processing. Process 500 may then continue with a step 515, wherein a quantum psychothotonic algorithm may be developed to process the clean database 812 or 814 and may be subsequently executed on a quantum computer 802, 804. Executing the algorithm may produce results, which provide analysis and insight for viewers' emotional response. The analysis and insights may then be used in informing algorithmic decisions directed at influencing viewer decision making in a step 520 of process 500.

The analysis and insights are illustrated by example in the (B)(E)(D) vector analysis in the previous “Car Buying” example whereby the additional data points are mapped from the probabilistic internal image wave state to an external unit sphere tracing a curve in space and time. The (B)(E)(D) data points reveal crucial information about the car buyer's state of mind as it transitions in time reacting to external stimulus. Upon recording this new type of data, aligned with traditional demographic information, and applying traditional statistical methods may yield a better understanding of consumer behavior.

In certain embodiments of the invention, referring to FIG. 5 and FIG. 8, the disclosed methods 500 may involve mining, organizing, and aggregating data to centralized database 812 or 814 with demographic and psychological user information. Developers may then architect quantum psychothotonic algorithms, subsequently embedding the algorithms on a quantum computer to process the information from centralized database 812 or 814. The quantum algorithms may then be executed to produce instructions for influencing user behavior. The resulting instructions may be linked to the internet 810 to influence decision making in a variety of marketing and advertising contexts. For example, without limitation, an online shopping website may use the instructions to command specific ads (images) toward individual users.

In certain embodiments of the invention, the disclosed methods may include data mining information and creating database 812 or 814 with demographic, emotional, and psychological information. A model may be built to process the data, structuring software toward a specific end goal or directed at solving a specific problem. Subsequently, the psychothotonic software may be embedded on quantum computational hardware 802, 804, producing instructions for influencing user decisions.

The software in one embodiment requires the integration of quantum circuits specifically in the implementation of a four-qubit model (FIG. 3) capturing a user's response from the psychothotonic questionnaire by first applying Hadamard gates to each qubit and applying the appropriate R(X) or I gate (FIG. 4) based upon the users response to a series of psychothotonix questions aligned with traditional demographic data resulting in a probabilistic output (historgram). One embodiment of the sample code for creating a quantum circuit as described using Python (Qiskit) is as follows:

from qiskit import QuantumRegister, ClassicalRegister, QuantumCircuit

from numpy import pi

qreg_q=QuantumRegister (4, ‘q’)

creg_c=ClassicalRegister (4, ‘c’)

circuit=QuantumCircuit (qreg_q, creg_c)

circuit.h(qreg_q[0])

circuit.h(qreg_q[1])

circuit.h(qreg_q[2])

circuit.h(qreg_g[3])

circuit.rx(pi/(3*1), qreg_q[0])

circuit.rx(-pi/(3*1), qreg_q[1])

circuit.rx(-pi/(3*1), qreg_q[2])

circuit.id(qreg_g[3])

circuit.measure(qreg_q[0], creg_c[0])

circuit.measure(qreg_q[1], creg_c[1])

circuit.measure(qreg_q[2], creg_c[2])

circuit.measure(qreg_q[3], creg_c[3])

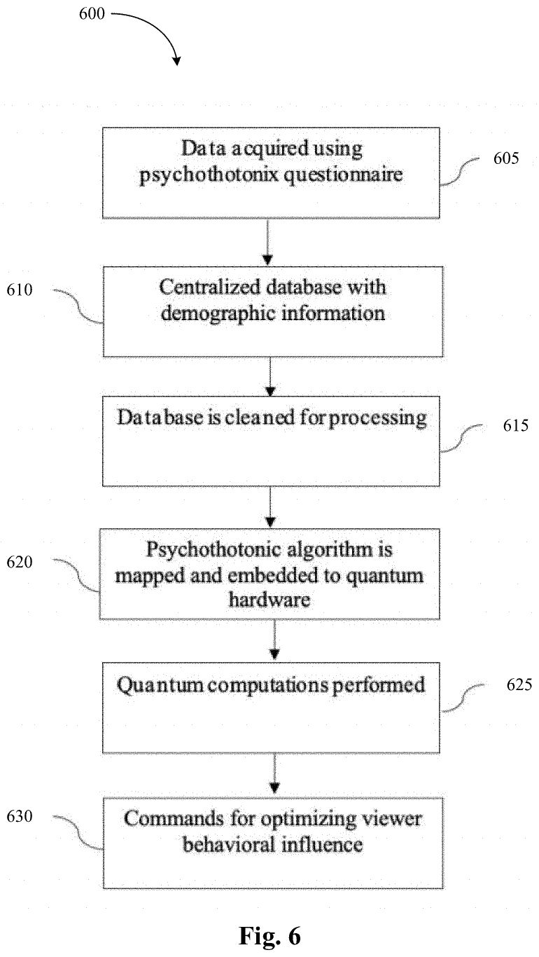

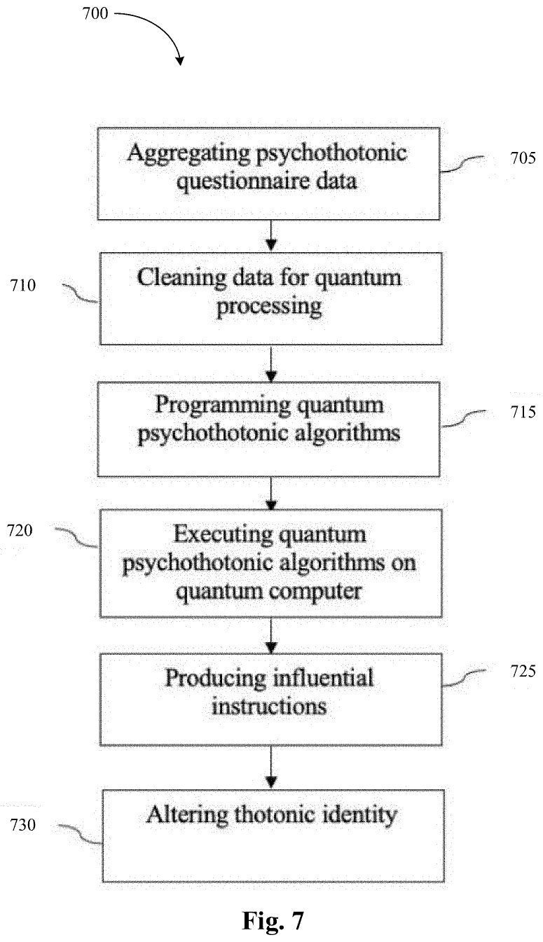

As the psychothotonix questionnaire is completed, the users change in internal mental state may also be simultaneously mapped to a unit sphere and traced as a curve using tensor calculus in accordance with the images and questions capturing data as it pertains to a measurable change in emotional/behavioral/decision states relative to an image in time-space (building a psychothotonix profile). In another embodiment, Image sequences could also be integrated with a hyperspectral camera while capturing the same (B)ehavioral (E)motional (D)ecision data points a frame at a time measuring response to image stimulus while developing a profile. Upon gathering enough data points to provide an appropriate confidence interval, traditional code may be utilized for the purpose of displaying images/video that are statistically likely to induce the desired (B) or (E) or (D). See FIG. 5, FIG. 6 and FIG. 7 for a flow chart of various embodiments of the algorithm. The resulting instructions may be linked to the internet 810 to influence decision making by manipulating thotonic identity in a variety of political contexts. For example, without limitation, a campaign may use the instructions with psychothotonic software to command specific political ads (images) toward individual voters based on demographic data. In certain embodiments, a psychothotonic questionnaire may be issued to a target audience. Similar to a traditional survey, the initial questions may capture the observer's general demographics, which may be useful for segmentation. Typical demographic questions may include, for example, without limitation, age, gender, income, level of education, occupation, ethnicity, religion and family structure. Moreover, images may be shown to viewers with GUI 840 for associative alignment SEE (Image_Example1.pdf FIG?)

The images may be constructed to reveal the internal emotional and behavioral image states of the observer. The images may offer the viewer one or more valid stable external images that may be intertwined with one another to create a stable dualistic emotional, behavioral internal image entangled with the viewer's identity. Once an adequate number of sampling questions have been processed to ascertain a temporal emotional behavioral profile, experimental content may be injected to ascertain effectiveness as it relates to changing thotonic identity.

Many aspects of the present invention may draw on the four basic human emotional states: happy, sad, angry, and afraid, and map the emotional states to the four basic human behavioral states: accept, resist, control, flow, using a four-qubit architecture, for example, as shown in FIG. 3. Ultimately, the emotional states may influence how humans perceive their environment and the resulting behavioral response impacting human interaction with objective reality, thereby manifesting probabilistic immaterial image waves into material change. The following equation may be used to map the emotional states to the four basic behavioral states:

|ω [symbol] =α|0000 [symbol] +β|111

[symbol]

Upon reviewing the above wave equation, it may be intuitive that a human in the following emotional behavioral states would be the most susceptible to social programming.

In certain embodiments, the present invention may utilize quantum image wave equations:

Referring to FIG. 5.5, the first 550 and second 551 timeline images demonstrate the principle of duality between the external and internal universe. In the first timeline 550, the single photon psychothotonix camera, 100 percent resolves the external universe quantum particle (solid circle) and the probability amplitude of the duality wave is cos=1, the mass is real, mc².

In the second timeline 551, the brain, 100 percent resolves the internal universe quantum particle from the camera (solid circle) and the probability amplitude of the wave is i sin=1, the mass is considered imaginary, imc². Consequently, the probability amplitudes fit as vectors on a unit sphere in the complex plane (Hilbert space).

In the first 550 and second 551 perception equations, the instantaneous amplitudes in time (the derivatives) depend on the two image processing events (camera and brain) (coupled differential equations, ω11, ω12, ω21, ω22, t,it and −t,−it).

dP+(t)/dt=i×ω11P+(t)−i×ω12P−(t)

dP−(t)/dt=i×ω21P+(t)−i×ω22P−(t)

The omegas (ω) are the frequencies of the two single photons entangled in the process and the (empty circles) represent the quantum shutter speeds (camera and brain) of the external and internal universes—related by planks constant divided by the single photons energy differences. The other two timelines 552, 553 are relative to another person “Universe B”, which can be called a dual parallel universe ad infinitum (Universe A,B,C,D . . . ).

The Modality of Consciousness (probabilistic image frame rate) is an internal dualistic image wave—subconscious/collective unconscious/dream state /infinite, |0>=±∞ and external image wave—finite awake/conscious, |1>=|1>=ℏ/ΔE The image frame rate of the brain can be zero as well as ±∞, as such it could also be the same frame rate as a camera (i.e., a photonic duplicate of the external image creating a reference point of objective reality). But the image rate of the camera is thus far limited to ℏ/ΔE (the energy it takes to switch frames between single coherent photons scattering off the quantum particle—the shutter speed of the universe. ℏ/ΔE is in units of joules-seconds. Energy (“E”) is in units of joules. So, Δt =ℏ/ΔF the frame rate of the brain can yield internal time like space that may be incongruent with the external frame rate or external light-like images congruent with the external frame rate. The frame rates are probabilistic and relativistic. Consequently, a person can interpret the blend of these images (internally) as past, present, or future moving in a positive (forward) or negative (backwards) direction in a non-linear, random, or coherent fashion. The brain's light cone is different than the external light cone. The frame rate of the camera from this point of view is Δt=ℏ/ΔF which can be set to a unit value when the camera is working at the quantum shutter speed of the universe—two single photons from a perfect coherent laser source. This model is thus an expanded version of the Schrodinger equation and wave function.

In certain embodiments, the present invention may utilize the following generalized wave equations, including, for example, without limitation, a Hamiltonian and a Dualitonian:

dP(t)/dt=ΣDi,jPj

(r)=cos θ+i×sin θ

The first equation may be the Hamiltonian equation in quantum mechanics, and the second equation may be the Dualitonian equation capturing the duality of photonic and thotonic image waves that make up conscious, perception.

FIG. 6 illustrates a flow chart of an exemplary method for gathering and utilizing psychothotonix questionnaire data, in accordance with an embodiment of the present invention. Referring to FIG. 6 and FIG. 8, In a step 605 of method 600, data may be acquired from a target audience with GUI 840 through, for example, without limitation, psychothotonix questionnaires. The data may be centralized in database 812 or 814 with demographic information in a step 610 of method 600. Method 600 may then continue with a step 615 in which database 812 or 814 may be cleaned for processing. In a step 620 of method 600, a psychothotonic algorithm may be mapped and embedded to quantum hardware 802, 804. Quantum computations may then be performed on the data stored in the cleaned, centralized database 812 or 814 in a step 625 of method 600. Subsequently, in a step 630 of method 600, commands may be used for optimizing viewer behavioral influence. Commands in the form of computer code that displays particular images or video in concordance with demographic information linked to a (B)(E)(D) algorithm designed to enhance the opportunity of conversion for the particular (D)ecision goal.

FIG. 7 illustrates a flow chart of an exemplary method for utilizing psychothotonic data for altering a thotonic identity, in accordance with an embodiment of the present invention. Referring to FIG. 7 and FIG. 8, method 700 may begin with a step 705 in which psychothotonic questionnaire data may be aggregated. The data may be cleaned for quantum processing in a step 710 of method 700. Method 700 may then continue with a step 715 in which quantum psychothotonic algorithms may be programmed. The quantum psychothotonic algorithms may be executed on a quantum computer 802, 804 in a step 720 of method 700. In a step 725 of method 700, influential instructions may then be produced, and in a step 725 of method 700, thotonic identity may be altered.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied. Such computers referenced and/or described in this disclosure may be any kind of computer, either general purpose, or some specific purpose computer such as, but not limited to, a workstation, a mainframe, GPU, ASIC, etc. The programs may be written in C, or Java, Brew or any other suitable programming language. The programs may be resident on a storage medium, e.g., magnetic or optical, e.g., without limitation, the computer hard drive, a removable disk or media such as, without limitation, a memory stick or SD media, or other removable medium. The programs may also be run over a network, for example, with a server or other machine sending signals to the local machine, which allows the local machine to carry out the operations described herein.

FIG. 8 is a block diagram depicting an exemplary client/server system which may be used by an exemplary web-enabled/networked embodiment of the present invention.

A communication system 800 includes a multiplicity of clients with a sampling of clients denoted as a client 802 and a client 804, a multiplicity of local networks with a sampling of networks denoted as a local network 806 and a local network 808, a global network 811 and a multiplicity of servers with a sampling of servers denoted as a server 812 and a server 814. Clients 802 and/or 804 may be configured to present the specialized psychothotonix questionnaires derived from the emotional behavioral plane shown in FIG. 1, to individuals which may be used to determine the individual's emotional response, behavioral response, and/or internal response to a stimulus. The stimulus may be any type of stimulus known in the art, such as, without limitation, images, videos, advertisements, etc. For instance, without limitation, an individual may be presented a video commercial for evaluating the individual's consumer opinion. The video commercial may be presented one scene at a time while the participant may be prompted with a psychothotonix question after each scene is presented. The emotional/behavioral state of the individual may be recorded while responding to the psychothotonix questionnaire.

Client 802 may communicate bi-directionally with local network 806 via a communication channel 816. Client 804 may communicate bi-directionally with local network 808 via a communication channel 818. Local network 806 may communicate bi-directionally with global network 810 via a communication channel 820. Local network 808 may communicate bi-directionally with global network 810 via a communication channel 822. Global network 810 may communicate bi-directionally with server 812 and server 814 via a communication channel 824. Server 812 and server 814 may communicate bi-directionally with each other via communication channel 824 wherein server 812 or server 814 may be configured as a (centralized) database for storing data acquired from the specialized psychothotonix questionnaire. Furthermore, clients 802, 804, local networks 806, 808, global network 810 and servers/database 812, 814 may each communicate bi-directionally with each other. For example, mining, organizing, and aggregating data to centralized database 812 or 814 with demographic and psychological user information acquired from the target audience with the psychothotonix questionnaires through clients 802, 804.

In one embodiment, global network 810 may operate as the Internet. It will be understood by those skilled in the art that communication system 800 may take many different forms. Non-limiting examples of forms for communication system 800 include local area networks (LANs), wide area networks (WANs), wired telephone networks, wireless networks, or any other network supporting data communication between respective entities.

Clients 802 and 804 may take many different forms. Non-limiting examples of clients 802 and 804 may include quantum computers, quantum hardware, adiabatic quantum computers, gate model quantum computer, personal computers, general-purpose computers, special purpose computers, personal digital assistants (PDAs), cellular phones and smartphones which may be used for running the quantum psychothotonic algorithms that may process the information from the centralized database 812 or 814.

Client 802 and 804 may include a CPU 826, a pointing device 828, a keyboard 830, a microphone 832, a printer 834, a memory 836, a mass memory storage 838, a GUI 840, a video camera 842, an input/output interface 844 and a network interface 846. Keyboard 830, microphone 832, video camera 842, and/or input/output interface 844 may be configured to acquire demographic data. While GUI 840 may be configured to present the specialized questionnaire using psychothotonic principles.

CPU 826, pointing device 828, keyboard 830, microphone 832, printer 834, memory 836, mass memory storage 838, GUI 840, video camera 842, input/output interface 844 and network interface 846 may communicate in a unidirectional manner or a bi-directional manner with each other via a communication channel 848. Communication channel 848 may be configured as a single communication channel or a multiplicity of communication channels.

CPU 826 may be comprised of a single processor or multiple processors. CPU 826 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general-purpose microprocessors.

As is well known in the art, memory 836 is used typically to transfer data and instructions to CPU 826 in a bi-directional manner. Memory 836, as discussed previously, may include any suitable computer-readable media, intended for data storage, such as those described above excluding any wired or wireless transmissions unless specifically noted. Mass memory storage 838 may also be coupled bi-directionally to CPU 826 and provides additional data storage capacity and may include any of the computer-readable media described above. Mass memory storage 838 may be used to store programs, data and the like and is typically a secondary storage medium such as a hard disk. It will be appreciated that the information retained within mass memory storage 838, may, in appropriate cases, be incorporated in standard fashion as part of memory 836 as virtual memory.

CPU 826 may be coupled to GUI 840. GUI 840 may enable a user to view the operation of computer operating system and software that may include the specialized psychothotonix questionnaires, software representing the two-state system, online shopping software, etc. CPU 826 may be coupled to pointing device 828. Non-limiting examples of pointing device 828 include computer mouse, trackball and touchpad. Pointing device 828 enables a user with the capability to maneuver a computer cursor about the viewing area of GUI 840 which may contain the specialized psychothotonix questionnaires and may select areas or features in the viewing area of GUI 840 to provide psychothotonix questionnaire responses. CPU 826 may be coupled to keyboard 830. Keyboard 830 enables a user with the capability to input alphanumeric textual information such as but not limited to the psychothotonix questionnaire responses to CPU 826. CPU 826 may be coupled to microphone 832. Microphone 832 enables audio produced by a user to be recorded, processed, and communicated by CPU 826. CPU 826 may be connected to printer 834. Printer 834 enables a user with the capability to print information to a sheet of paper. CPU 826 may be connected to video camera 842 that may provide alternative methods for psychothotonix data gathering. Video camera 842 may be used to take a (hyperspectral) image or picture of an individual being exposed to a stimulus and may enable video produced or captured by user to be recorded, processed, and communicated by CPU 826. The (hyperspectral) image may model the anatomical details (i.e., combinations of independent facial muscles) of the individual's facial features being exposed to the stimulus and may uniquely correspond to the individual's internal state in response to the stimulus.

CPU 826 may also be coupled to input/output interface 844 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 826 may be coupled to network interface 846 which enables communication with an external device such as a (centralized) database or a computer or telecommunications or internet network using an external connection shown generally as communication channel 816, which may be implemented as a hardwired or wireless communications link using suitable conventional technologies. With such a connection, CPU 826 might receive information from the network/Internet, or might output information to a network/Internet in the course of performing the method steps described in the teachings of the present invention.

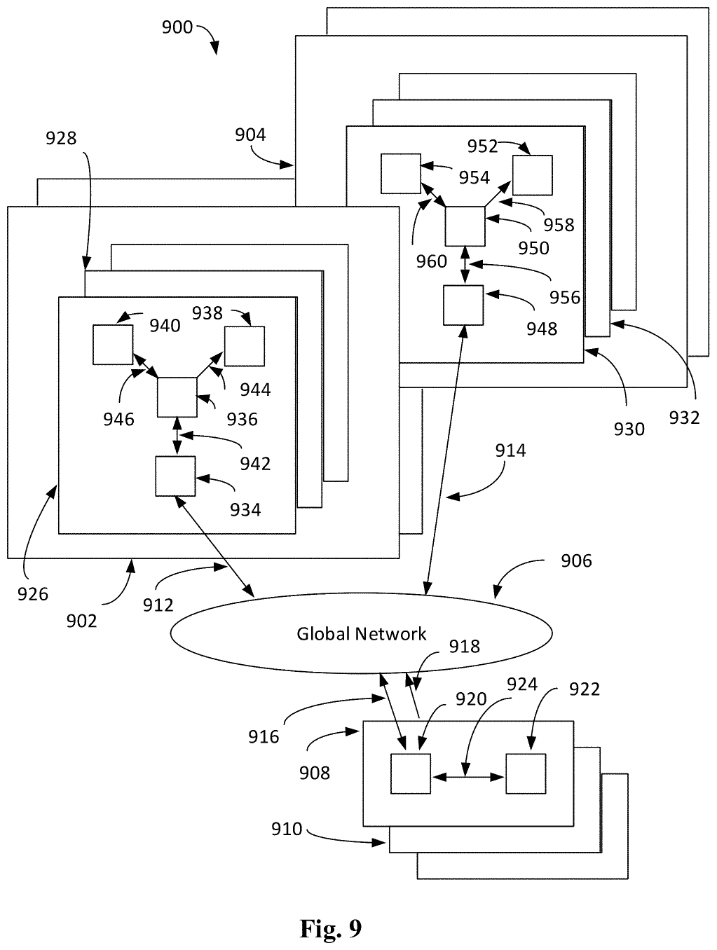

FIG. 9 illustrates a block diagram depicting a conventional client/server communication system, which may be used by an exemplary web-enabled/networked embodiment of the present invention.

A communication system 900 includes a multiplicity of networked regions with a sampling of regions denoted as a network region 902 and a network region 904, a global network 906 and a multiplicity of servers with a sampling of servers denoted as a server device 908 and a server device 910.

Network region 902 and network region 904 may operate to represent a network contained within a geographical area or region. Non-limiting examples of representations for the geographical areas for the networked regions may include postal zip codes, telephone area codes, states, counties, cities, and countries. Elements within network region 902 and 904 may operate to communicate with external elements within other networked regions or within elements contained within the same network region.

In some implementations, global network 906 may operate as the Internet. It will be understood by those skilled in the art that communication system 900 may take many different forms. Non-limiting examples of forms for communication system 900 include local area networks (LANs), wide area networks (WANs), wired telephone networks, cellular telephone networks or any other network supporting data communication between respective entities via hardwired or wireless communication networks. Global network 906 may operate to transfer information between the various networked elements.

Server device 908 and server device 910 may operate to execute software instructions including but not limited to quantum psychothotonic algorithms, store information, support database operations and communicate with other networked elements. Non-limiting examples of software and scripting languages which may be executed on server device 908 and server device 910 include C, C++, C# and Java.

Network region 902 may operate to communicate bi-directionally with global network 906 via a communication channel 912. Network region 904 may operate to communicate bi-directionally with global network 906 via a communication channel 914. Server device 908 may operate to communicate bi-directionally with global network 906 via a communication channel 916. Server device 910 may operate to communicate bi-directionally with global network 906 via a communication channel 918. Network region 902 and 904, global network 906 and server devices 908 and 910 may operate to communicate with each other and with every other networked device located within communication system 900.

Server device 908 includes a networking device 920 and a server 922. Networking device 920 may operate to communicate bi-directionally with global network 906 via communication channel 916 and with server 922 via a communication channel 924. Server 922 may operate to execute software instructions and store information.

Network region 902 includes a multiplicity of clients with a sampling denoted as a client 926 and a client 928. Client 926 includes a networking device 934, a processor 936, a GUI 938 and an interface device 940. Non-limiting examples of devices for GUI 938 include monitors, televisions, cellular telephones, smartphones, and PDAs (Personal Digital Assistants). Non-limiting examples of interface device 940 include pointing device, mouse, trackball, scanner, and printer. Networking device 934 may communicate bi-directionally with global network 906 via communication channel 912 and with processor 936 via a communication channel 942. GUI 938 may receive information from processor 936 via a communication channel 944 for presentation to a user for viewing. Interface device 940 may operate to send control information to processor 936 and to receive information from processor 936 via a communication channel 946. Network region 904 includes a multiplicity of clients with a sampling denoted as a client 930 and a client 932. Client 930 includes a networking device 948, a processor 950, a GUI 952 and an interface device 954. Non-limiting examples of devices for GUI 938 include monitors, televisions, cellular telephones, smartphones, and PDAs (Personal Digital Assistants). Non-limiting examples of interface device 940 include pointing devices, mousse, trackballs, scanners, and printers. Networking device 948 may communicate bi-directionally with global network 906 via communication channel 914 and with processor 950 via a communication channel 956. GUI 952 may receive information from processor 950 via a communication channel 958 for presentation to a user for viewing. Interface device 954 may operate to send control information to processor 950 and to receive information from processor 950 via a communication channel 960.

For example, consider the case where a user interfacing with client 926 may want to execute a networked application. A user may enter the IP (Internet Protocol) address for the networked application using interface device 940. The IP address information may be communicated to processor 936 via communication channel 946. Processor 936 may then communicate the IP address information to networking device 934 via communication channel 942. Networking device 934 may then communicate the IP address information to global network 906 via communication channel 912. Global network 906 may then communicate the IP address information to networking device 920 of server device 908 via communication channel 916. Networking device 920 may then communicate the IP address information to server 922 via communication channel 924. Server 922 may receive the IP address information and after processing the IP address information may communicate return information to networking device 920 via communication channel 924. Networking device 920 may communicate the return information to global network 906 via communication channel 916. Global network 906 may communicate the return information to networking device 934 via communication channel 912. Networking device 934 may communicate the return information to processor 936 via communication channel 942. Processor 996 may communicate the return information to GUI 938 via communication channel 944. User may then view the return information on GUI 938.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC § 112 (6)/(f) it is intended that the corresponding means for and/or steps for carrying out the claimed function are the ones that are locally implemented within the jurisdiction of the USA, while the remaining aspect(s) performed or located remotely outside the USA are not intended to be construed under 35 USC § 112 (6) pre-AIA or 35 USC § 112 (f) post AIA. In some embodiments, the methods and/or system components which may be located and/or performed remotely include, without limitation: cloud-based quantum computation.

It is noted that according to USA law, all claims must be set forth as a coherent, cooperating set of limitations that work in functional combination to achieve a useful result as a whole. Accordingly, for any claim having functional limitations interpreted under 35 USC § 112 (6)/(f) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC § 112 (6)/(f) is/(are) dependent on one or more remote servers located outside the USA, it is intended that each such recited function under 35 USC § 112 (6)/(f) is to be interpreted as the function of the local system receiving the remotely generated information required by a locally implemented claim limitation, wherein the structures and or steps which enable, and breath life into the expression of such functions claimed under 35 USC § 112 (6)/(f) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present patent application, and “35 USC § 112 (6)/(f)” should be replaced with the closest corresponding statute in the patent laws of such pertinent country or countries or legal organization(s).

All the features disclosed in this specification, including any accompanying abstract and drawings, may be replaced by alternative features serving the same, equivalent, or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112(f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112(6) (post AIA 112(f)) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing a system and method for quantum psychothotonix according to the present invention will be apparent to those skilled in the art. Various aspects of the invention have been described above by way of illustration, and the specific embodiments disclosed are not intended to limit the invention to the particular forms disclosed. The particular implementation of the system and method for quantum psychothotonix may vary depending upon the particular context or application. By way of example, and not limitation, the system and method for quantum psychothotonix described in the foregoing were principally directed to influencing emotional and behavioral states implementations; however, similar techniques may instead be applied to advertising, a new type of quantum computer that maps external and internal images, four dimensional decision models taking into consideration human emotional behavioral image states as they change in time/space, social and behavioral engineering, image processing beyond the Johnson Criteria-military intelligence, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

Only those claims which employ the words “means for” or “steps for” are to be interpreted under 35 USC 112, sixth paragraph (pre-AIA) or 35 USC 112(f) post-AIA. Otherwise, no limitations from the specification are to be read into any claims, unless those limitations are expressly included in the claims.

What is claimed is:

1. A method for influencing a response, the method comprising:
presenting, with a client device, a questionnaire derived from an emotional behavioral plane;
wherein the questionnaire derived from the emotional behavioral plane is configured to be operable for a demographic data acquisition;
acquiring, with the client device, a demographic response data, in which the demographic response data comprise at least an emotional response data and a behavioral response data, in response to at least one or more stimulus;
aggregating the demographic response data to a centralized database;
processing the demographic response data including the emotional response data and the behavioral response data with a computer program;
embedding the computer program to a quantum hardware;
executing the computer program; and
producing at least one or more commands or instructions, wherein the at least one or more commands or instructions are configured to be operable for influencing at least one of, a decision making in at least one of a variety of marketing and advertising contexts, a thotonic identity in a variety of political contexts, how humans perceive their environment, and viewer or shopper behavior.

2. The method of claim 1, wherein the two-state system defining the emotional and behavioral response is embedded on the quantum computer using a four-qubit architecture.

3. The method of claim 2, wherein a two-state system defining the emotional response and behavioral response is embedded on an adiabatic quantum hardware using a four-qubit architecture, in which said method further comprising processing the psychothotonix response data to alter the thotonic identity.

4. The method of claim 1, wherein a two-state system defining the emotional response and behavioral response is embedded on the quantum hardware using a four-qubit architecture.

5. The method of claim 4, wherein the at least one or more commands or instructions are configured to influence television viewers.

6. The method of claim 3, wherein the at least one or more commands or instructions are configured to influence voters in an election.

7. The method of claim 2, wherein the at least one or more commands or instructions are configured to influence shoppers in online markets with targeted advertising.

8. The method of claim 1, wherein the computer program defines the behavioral response and the emotional response as a two-state system, in which the method further comprising:
presenting the one or more stimulus;
associating a behavioral response while the one or more stimulus are presented; and
acquiring an emotional response with the questionnaire corresponding to the presented one or more stimulus.

9. The method of claim 2, further comprising:
initializing the four-qubits with Hadamard gates prior to processing the response data;
executing and applying the Hadamard gates for optimizing viewer influence based on viewer feedback;
processing the software to control viewer content; and
manipulating the thotonic identity to achieve advertising goals.

10. The method of claim 5, further comprising:
controlling viewer content; and
manipulating the thotonic identity to achieve campaign goals.

11. The method of claim 2, wherein the method is used to influence voters in an election.

12. The method of claim 11, further comprising:
initializing the qubits with Hadamard gates according to the psychothotonic emotional response data and behavioral response data; and
executing the psychothotonic computer program.

13. The method of claim 2, wherein the at least one or more commands or instructions control an online shopping software, influence online shoppers, and make purchase recommendations.

14. The method of claim 2, wherein the psychothotonic computer program defines viewer emotional response data and behavioral response data as a two-state quantum system.

15. The method of claim 2, in which embedding the psychothotonic computer program to the quantum hardware includes mapping the computer program to four qubits and defining viewer emotional and behavioral response as a two-state quantum system.

16. The method of claim 2, in which embedding the psychothotonic computer program to the quantum hardware includes mapping the program to four qubits, processing the computer program, and generating commands for influencing viewer thotonic identities.

17. The method of claim 6, in which the at least one or more commands or instructions that are configured to influence voters in an election includes controlling information in an online network to illicit behavioral responses in association with particular candidates.

18. The method of claim 2, wherein the psychothotonic computer program is configured to control quantum gate matrices for psychothotonic analysis.

19. A software program product having an executable program stored in a non-transitory computer-readable storage medium, wherein the executable program instructs at least one or more processors to perform a method comprising:
presenting a psychothotonix questionnaire, wherein said psychothotonix questionnaire is derived from an emotional behavioral plane;
presenting a stimulus, in which said stimulus comprise images or videos of advertisements or television shows;
acquiring a psychothotonix response data based at least on the stimulus and psychothotonix questionnaire, in which the psychothotonix response data comprise at least an emotional response data and a behavioral response data;
aggregating the psychothotonix response data to a centralized database;
defining the emotional response data and the behavioral response data as a two-state system;
embedding a software representing the two-state system on a quantum computer;
executing the software representing the two-state system; and
producing at least one or more commands or instructions that are configured to be operable for influencing at least one of, a decision making in at least one of a variety of marketing and advertising contexts, a thotonic identity in a variety of political contexts, how humans perceive their environment, and viewer behavior.

20. A method for gauging target population response comprising:
presenting, with a client device, a psychothotonix questionnaire, wherein said psychothotonix questionnaire is derived from an emotional behavioral plane;
acquiring a psychothotonix response data based on the psychothotonix questionnaire, in which the psychothotonix response data comprise at least an emotional response data and a behavioral response data;
aggregating the psychothotonix response data to a centralized database;
processing the psychothotonix response data with a psychothotonic computer program;
embedding the psychothotonic computer program to a quantum hardware;
executing the psychothotonic computer program; and
producing at least one or more commands that are configured to be operable for influencing at least one of, a decision making in at least one of a variety of marketing and advertising contexts, how humans perceive their environment, and viewer behavior.
